(19) United States
(12) Patent Application Publication
(10) Pub. No.: US 2002/0000361 A1
(43) Pub. Date: Jan. 3, 2002

(54) Line pressure control device for packaging line

(76) Inventor: Jeffrey Reilly, Killingworth, CT (US)

Correspondence Address: CANTOR COLBURN, LLP, 55 GRIFFIN ROAD SOUTH, BLOOMFIELD, CT, 06002

(21) Appl. No.: 09/892,034

(22) Filed: Jun. 26, 2001

Related U.S. Application Data
(60) Provisional application No. 60/215,426, filed on Jun. 30, 2000.

(51) Int. Cl. B65G 43/00

(52) U.S. Cl. 198/460.1

(57) ABSTRACT

The present invention maintains optimum line pressure in a conveyor system under varying operating conditions by adjusting the speed at which package cartons are delivered to downstream devices. For example, when the speed of the downstream device is reduced, the gap between the package cartons is maintained by reducing the speed of a first upstream belt so as maintain the desired gap distance between package cartons. Once the downstream device increases its speed again, the sensing mechanism will detect that the line pressure is dropping and will simultaneously increase the speed of the first belt so that the programmed gap is maintained and the line pressure is likewise maintained at an optimum level.

### FIELD OF THE INVENTION

This invention relates generally to conveyor systems and more particularly to an assembly for use in conveyor systems to control the line pressure so as to permit effective further downstream processing on a packaging line.

### BACKGROUND OF THE INVENTION

The packaging process has evolved into a highly automated processing system where products are manufactured and then delivered to a packaging station. It is known in the packaging field to provide a continuous feed of articles, such as food items including bottles, spaced at precise intervals in order to most effectively accommodate interaction with a downstream processing station of the packaging line, such as a slitter/sealer which serves to complete the packaging processing by cutting package flaps, packaging, orienting, or folding the flaps and adhering the flaps to the package carton itself. However, an associated disadvantage of many prior art devices is that the devices often have a non-uniform supply of product from upstream equipment. For example, the upstream equipment provides surges of product from time to time with a greater number of products being sent downstream.

One of the associated disadvantages of these conventional devices is that the line pressure of the system is not maintained at optimum operating conditions but rather is too excessive or is too low resulting in less than optimum operating conditions. Therefore, either too many package cartons will stack up against one another resulting in increasing line pressure or too few package cartons will be transferred downstream resulting in low line pressure and inefficient operating conditions or carton crushing. In typical conventional devices, one or more belt mechanisms are periodically stopped so as to curtail the advancement of the package cartons and thus reduce line pressure in the system. Once the line pressure is reduced, the belt mechanisms are started again and the package cartons are advanced downstream. This process may be repeated a number of times during normal operation in an effort to maintain the desired line pressure in the system. While this process may serve to reduce line pressure, it is not an especially efficient manner of reducing the line pressure because various working components are required to be placed off line and requires supervision. Also, large gaps or spaces are created in the packaging line when the belt mechanisms are stopped.

It is therefore desirable to provide an automated process in which the line pressure of the system is continuously monitored and maintained at a predetermined level which permits the system to operate at an efficient line pressure.

### SUMMARY OF THE INVENTION

The above discussed and other drawbacks and deficiencies are overcome or alleviated by a line pressure control device for use in a packaging line. According to the present invention, the line pressure of the system is maintained by monitoring the product package cartons as they are transferred from a first belt to a second belt as the cartons continue to be advanced in a downstream direction. More specifically, the present invention utilizes a sensing mechanism which serves to detect the speed of the package carton as it passes by a sensor which forms a part of the sensing mechanism. The sensing mechanism also monitors the distance between next adjacent package cartons as they travel by the sensor in a downstream direction.

The present system is designed such that the first belt (high friction) is powered by a first motor and the second belt (low friction) is powered by a second motor. The first belt and the first motor are interfaced with a controller which communicates with the sensing mechanism so that information sensed by the sensor is provided to the programmable controller. The controller permits a user to input specific operating conditions, including but not limited to, the length of the package carton, the processing speeds of downstream devices, and the desired gap between next adjacent package cartons. Once the user selects the desired gap based on a number of considerations enumerated herein later, the present system is designed so that the gap between next adjacent package cartons is maintained and this corresponds into maintaining the line pressure of the system.

The sensing mechanism preferably comprises a photoeye device and an opposing reflector and is designed to detect the time period for which the sensor beam is obstructed by the passing package carton and the time period for which the sensor beam is reflected back to the sensor, indicating that there are is no package carton passing through the sensor beam (this corresponds to a gap between package cartons). Because the programmable controller and the sensing mechanism communicate with each other, the controller includes a comparator type device which compares the sensed information from the sensing mechanism with stored optimum operating conditions. The line pressure is maintained at the desired level by adjusting the speed of the first belt so that the package cartons are transferred to the second belt with the gap therebetween being kept in tact. For example, if the speed of one of the downstream devices is reduced and less package cartons are being processed, the package cartons will begin to stack against one another along the downstream belts and this leads to increased line pressure. The present invention maintains the optimum line pressure under varying operating conditions by adjusting the speed at which the package cartons are delivered to the downstream devices along the downstream belts. For example, when the speed of the downstream device is reduced, the gap between the package cartons is maintained by reducing the speed of the first belt so as maintain the desired gap distance between package cartons. Once the downstream device increases its speed again, the sensing mechanism will detect that the line pressure is dropping and will simultaneously increase the speed of the first belt so that the programmed gap is maintained and the line pressure is likewise maintained at an optimum level. These advantageous features are possible because of the interfacing between the programmable controller, the sensing mechanism, and the first belt/first motor.

The above-discussed and other features and advantages of the present invention will be appreciated and understood by those skilled in the art from the following detailed description and drawings.

### BRIEF DESCRIPTION OF THE DRAWINGS

Referring to the Figures wherein like elements are numbered alike in the several Figures:

FIG. 1 is a simple schematic diagram of a conveyor system embodying the present invention;

FIG. 2 is a top plan view of a portion of a conveyor system according to one embodiment of the present invention; and

FIG. 3 is a side elevational view of the conveyor system of FIG. 1.

### DESCRIPTION OF THE PREFERRED EMBODIMENT

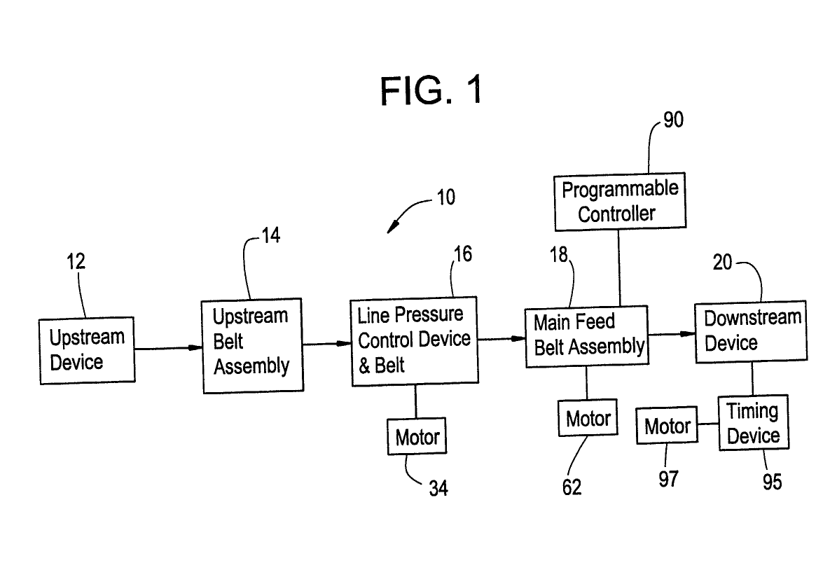

Referring first to FIG. 1 in which a simple schematic diagram illustrating the present invention is provided. According to the present invention, a conveyor system 10 is provided and can be used in a variety of applications and is particularly useful in the food or beverage packaging industries. The conveyor system 10 generally includes an upstream device 12 which may comprise any number of conventional upstream devices which are used to process the product before it is delivered to other upstream or downstream devices for further processing. It will be understood that the upstream device 12 may comprise more than one upstream device and/or transfer belts which link the upstream devices to one another. According to one embodiment of the present invention, the upstream device 12 is designed to feed products into package cartons which are then delivered downstream for further processing such that the products are delivered downstream in the package carton. The upstream device 12 is linked to an upstream belt assembly 14 which is designed to transport the package cartons holding the products to a line pressure control device and belt assembly according to the present invention and generally indicated at 16. As will be described in greater detail hereinafter, the line pressure control device and belt assembly 16 receives the package cartons from the upstream belt assembly 14 and maintains optimum spacing of the package cartons along the assembly 16 so as to maintain optimum line pressure. The assembly 16 communicates at another end with a main feed belt assembly 18 which transports the package cartons 100 from the assembly 16 to one or more downstream devices, generally indicated at 20 and described in greater detail hereinafter. It will be appreciated that the one or more downstream devices 20 may also include any number of belt assemblies (not shown) which are designed to transport the package cartons to additional processing stations. It is further understood that the configuration shown in FIG. 1 is merely exemplary in nature and that any number of configurations may be used so long as the line pressure control device and belt assembly 16 of the present invention is provided in the conveyor system 10.

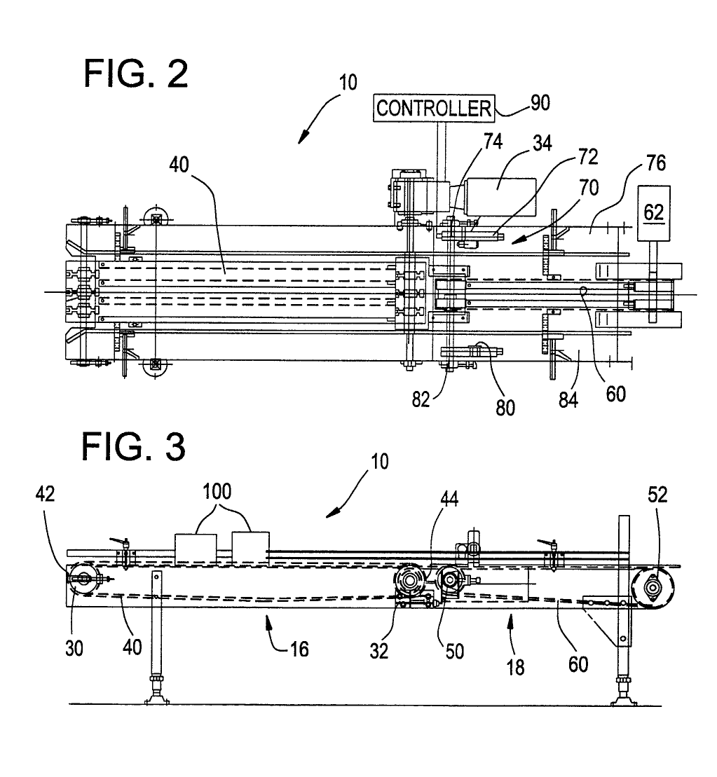

Now referring to FIGS. 1-3 which illustrate a section of the conveyor system 10 shown in FIG. 1. FIGS. 2 and 3 illustrate the relationship between the line pressure control device and belt assembly 16 and the main feed belt assembly 18. According to the present invention, the line pressure control device and belt assembly 16 includes a pair of first and second rotatable members 30, 32 which are driven by a motor 34. The motor 34 may comprise any number of suitable motors and for example, may comprise a servo motor, a stepper, a DC motor, a variable speed AC motor, hydraulic motor, pneumatic motor, or the like. A first belt 40 is disposed about the first and second rotatable members 30, 32 and provides a first conveying surface. Preferably, the first belt 40 is snugly fit about the first and second rotatable members 30, 32 so that a firm conveying surface is provided. The first belt 40 preferably comprises a high friction belt which prevents the package cartons 100 from excessive movement or slippage on the first belt 40 as the package cartons 100 are received from the upstream belt assembly and transported along the belt 40 to the main feed belt assembly 18. For example, one suitable first belt 40 is formed of a polymeric material having high friction characteristics and also includes a plurality of ribs (not shown) which provide a better engagement and retention surface for the package carton 100 during transportation thereover.

At a first end 42 of the assembly 16, the first belt 40 receives the package cartons 100 from the upstream belt assembly and a second end 44 of the assembly 16 comprises a transfer section where the package cartons 100 are transferred from the assembly 16 to the main feed belt assembly 18. The main feed belt assembly 18 also includes first and second rotatable members 50, 52 which serve to support a second belt 60 which provides a second conveyor surface. The main feed belt assembly 18 and more specifically, the second belt 60 thereof, is preferably driven by a separate second motor, generally indicated at 62. Alternatively, the second belt can be powered, partially or wholly, by a power take-off from a subsequent machine. According to the present invention, the second belt 60 preferably comprises a low friction support surface which permits the package cartons 100 to continue forward feeding along a surface of the second belt 60 and slip along the surface until the appropriate desired relationship is obtained between next adjacent package cartons 100. Any number of suitable low friction belts may be used as second belt 60.

The present invention includes a sensing mechanism 70 which is designed to sense a number of parameter including the distance between next adjacent package carton 100 as they travel along the first belt 40 and are transferred to the second belt 60 of the main feed belt assembly 18. The sensing mechanism 70 includes a sensor bracket 72 which supports a sensor 74 with the sensor 74 being moveable along a length of the sensor bracket 72 so that the sensor 74 may be positioned at a desired location. As best shown in FIG. 2, the sensor bracket 72 is located at a first side 76 of the main feed belt assembly 18 and extends generally parallel to the second belt 60. The sensor 74 is thus positioned adjacent to one edge of the moving second belt 60. In the illustrated embodiment, the sensor 74 and the sensor bracket 72 are disposed proximate to the motor 34 which serves to control the speed of the first belt 40. The sensor 74 may comprise any number of sensors so long as sensor 74 is capable of sensing the distance, if any, between next adjacent package cartons 100 as they are fed from the assembly 16 to the main feed belt assembly 18. Possible sensors include photoelectric sensors, ultrasonic sensors proximity sensors, cameras (video, line scanning, and the like), electronic switches, and the like, as well as combinations comprising at least one of the foregoing. In the embodiment with the photoelectric sensor, the sensing mechanism 70 further includes a reflector 80 adjustably disposed within a reflector bracket 82. The reflector bracket 82 is thus located on a second side 84 of the main feed assembly 18 and more specifically is located across from the sensor bracket 72 adjacent to the second belt 60. The reflector bracket 82 extends parallel to both the second belt 60 and the sensor bracket 72. Preferably, the lengths of the reflector bracket 82 and the sensor bracket 72 are similar so that the reflector 80 may be positioned directly across from the sensor 74 and the reflector 80 may be adjusted within the reflector bracket 82 so as to be directly across from the sensor 74 whenever the sensor 74 is adjusted within the sensor bracket 72. As is known in the art, the sensor 74 emits a light beam and if no object is disposed between the sensor 74 and the reflector 80, the beam will strike the reflector 80 and will return to the sensor 74. When the sensor 74 detects a reflected beam, the sensor 74 generates a first signal which is indicative of no object being sensed between the sensor 74 and the reflector 80. When an object, e.g., one of the package cartons 100 passes between the sensor 74 and the reflector 80, the beam is broken and the sensor 74 does not receive the reflected beam from the reflector 80. When this occurs, the sensor 74 calculates the amount of time that the beam is broken until the package carton 100 continues traveling along the second belt 60 and clears the beam resulting in the beam traveling across and contacting the reflector 80 which reflects the beam back to the sensor 74.

The sensing mechanism 70 communicates with a programmable controller 90 which is connected to and communicates with at least the motor 34. The programmable controller 90 controls the speed that the motor 34 is run at and more specifically, speed at which the first belt 40 is run. The programmable controller 90 is preferably designed so that the user may input selected parameters which govern how the line pressure control device and belt assembly 16 should be operated. For example, the user will preferably input the type of product being used, e.g., 24-12 ounce bottles; the length of the package carton 100; and the preselected optimum speed of the main feed belt assembly 18 in terms of the number of package cartons 100 per minute which pass along the main feed belt assembly 18 to the downstream device 20. Possible controllers include an electronic controller, computer, photoeye, microprocessor, programmable logic controller, and the like, as well as combinations thereof.

Typically, the main feed belt assembly 16 communicates with a timing device 95 which forms a part of the downstream device 20. The timing device 95 includes a number of lugs (not shown) which are designed to hold one individual package carton 100 being fed from the main feed belt assembly 18 to the one or more downstream devices 20, such as a slitter machine which serves to further process the package cartons 100 as for example by cutting flaps then packaging the flaps and/or adhering the flaps to the other structural parts of the package cartons 100 so that the package cartons 100 is fully enclosed and ready for further processing. The timing device 95 has an associated speed which is expressed in terms of number of cases per unit of time, e.g., cases per minute. The timing device 95 is preferably operated by a motor 97.

As previously mentioned, the programmable controller 90 communicates with the sensing mechanism 70 so that the operating conditions sensed by the sensor 74 are relayed to programmable controller 90. The programmable controller 90 includes a comparator type device which is designed to compare the sensed operating conditions with stored optimum operating conditions. As the package cartons 100 are transferred from the line pressure control device and belt assembly 16 to the main feed belt assembly 18, the package cartons 100 begin to abut one another because individual package cartons 100 are fed into the timing device 95 and the lugs thereof prevent the package cartons 100 from continued travel to downstream locations until the timing device 95 retracts the lugs and releases the package cartons 100 to downstream locations. As previously mentioned, the package carton 100 typically travels from the timing device 95 to the downstream device 20 by means of another conveyor system or the like. The timing device 95 thus has an associated speed which is often expressed in terms of cases per minute. In other words, the timing device 95 will only process a certain number of cases in a given time, such as one minute, and therefore, if the package cartons 100 are delivered to the timing device 95 at a greater rate than the processing speed of the timing device 95, the package cartons 100 begin to stack up against one another along one or more upstream conveyor belt assemblies which in this exemplary embodiment is the main feed belt assembly 18.

By inputting the length of the package carton 100 and the speed of the timing device 95, the programmable controller 90 calculates the time period which it should take for one package carton 100 to pass through the sensing mechanism 70. For example, if the length of the package carton 100 is 12 inches and the speed of the timing device is 60 cases per minute, one particular package carton 100 travels 60 feet per minute and therefore, it will take one (1) second for one package carton 100 to travel through the sensing mechanism 70. In other words, under desired optimum operating conditions, one package carton 100 being transferred onto the second belt 60 will obstruct the beam of the sensor 74 for one (1) second as it passes through the sensor beam. Thus, the sensor 74 should not see a reflected beam for 1 second and if the sensor 74 does not see a reflected beam for greater than or less than about 1 second, then the speed at which the package carton 100 is traveling is not the optimum speed and should either be increased or decreased. The sensing mechanism 70 and the sensor 74 also determines the reflection time of sensor 74. In other words, the sensor 74 will calculate the time period in which the beam is reflected back to the sensor 74. Because the user inputs into the programmable controller 90 the desired gap in terms of length between next adjacent package carton 100, the reflection time period can be determined in view of the length of the package carton 100 and the speed of the timing device 95 and second belt 60. For example, if the operating conditions are the above-mentioned conditions (package length is 12 inches and speed is 60 cases per minute), then under normal, optimum operating conditions, a programmed 4 inch gap will correspond to a reflection time period of 0.333 seconds. If the sensing mechanism 70 measures that the reflection time period is less than or greater than 0.33 seconds than the gap between next adjacent package cartons 100 is either too great or too small. The optimum gap to maintain between next adjacent package cartons 100 is selected and programmed into controller 90 according to a number of parameters including but not limited to product type, the specific layout of the line, and the overall speed of the line. The optimum desired gap for any given application does not vary according to the speed of the timing device 95 and therefore, the programmed gap should be maintained irrespective of the current speed of the timing device 95.

The speed of the timing device 95 will vary depending upon any number of operating conditions and other external conditions and events. For example, if there is a delay in the operation of the downstream device 20 or if one of the package carton 100 becomes misted as it travels from the main feed belt assembly 18 to one or more of the downstream devices 20, the timing device 95 retains each package carton 100 for a greater period of time so as not to release an excessive amount of package carton 100 to the one or more downstream devices 20. It will be appreciated that if the package cartons 100 are continuously fed to the timing device 95 at the same rate as before, the package cartons 100 will begin to stack against each other along the main feed belt assembly 18. This creates what is known as line pressure which is caused by the package cartons 100 stacking up against each other with little or no forward movement being made by the package cartons 100. As the package cartons 100 stack up against each other along the length of the second belt 60, the second belt 60 continues to be driven by the second motor 62. The force necessary to continue to drive the second belt 60 increases as the package cartons 100 stack against each other along the moving second belt 60 and this results in increasing friction between the package cartons 100 and the second belt 60. This is represented as line pressure within the conveyor system 10.

For example, if the speed of the second belt 60 (the low friction belt) slows down from 60 cases per minute to 30 cases per minute, then the 12 inch package carton 100 should pass the sensor 74 in 2 seconds under normal operating conditions. If the package carton 100 passes the sensor 74 in a time period either greater than or less than 2 seconds, then the optimum line pressure is not being achieved and either not enough package cartons 100 are being transferred to the timing device 95 or too many package cartons 100 are being transferred to the timing device 95 resulting in a line pressure build-up. For example, if one package carton 100 passes the sensor 74 in 1.75 seconds and not 2 seconds, the desired 4 inch gap is not being maintained and there is a reduction in line pressure. In contrast, if the package carton 100 took too long to pass the sensor 74, the gap is too small and should be increased. As will be described in greater detail hereinafter, the present invention is designed to compensate for this reduction in line pressure by adjusting the operating conditions of the system 10.

According to the present invention, the assembly 16 permits the conveyor system 10 to operate at optimum line pressures and maintain these optimum line pressures by monitoring and making any necessary adjustments relative to the speed of the first belt 40 so as to maintain the programmed gap between next adjacent package carton 100 and therefore maintain the desired optimum line pressure. Because the first belt 40 is driven by the first motor 34 which is independent of the motors 62, 97 which drive the second belt 60 and the timing device 95, the speed of the first belt 40 may be controlled by varying the speed of the motor 34. The programmable controller 90 receives information from the sensing mechanism 70 and because the programmable controller 90 communicates with the motor 34, the programmable controller 90 will direct the motor 34 to either increase or decrease its speed depending upon the observed operating conditions. This causes the speed of the first belt 40 to be accordingly adjusted. By carefully monitoring the time it takes for each package carton 100 to pass the sensor 74 and the reflection time period between next adjacent package cartons 100 (which corresponds to the gap), the present assembly 10 maintains optimum line pressure by adjusting the speed at which the package cartons 100 are transferred from the first belt 40 to the second belt 60. By maintaining the desired gap between next adjacent package cartons 100, the line pressure is controlled and maintained at the optimum rate.

It should be understood that although a specific example of the present invention has been provided, it should be understood that other embodiments are possible, including, but not limited to, the use of multiple equipment, e.g., additional sensors, belts, controllers, etc.

In contrast with the fully automated assembly 10 of the present invention, conventional assemblies typically maintain line pressure by having to start and stop one or more line belts in an effort to regulate and control the line pressure. For example, if the line pressure increases because package cartons 100 are stacking against one another a long the length of one or more line belts, an operator will shut down for a period of time one or more other line belts so as to permit one or more of the package cartons 100 to be processed by the timing device.

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. A conveyor system for controlling line pressure of articles being transported along the conveyor system, the system comprising:
a first belt assembly powered by a first motor;
a second belt assembly adjacent the first belt assembly so that the articles freely pass from a first belt of the first belt assembly to a second belt of the second belt assembly;
a sensing mechanism for sensing a gap distance between next adjacent articles as the articles pass from the first belt to the second belt; and
a controller operatively connected to the first motor and in communication with the sensing mechanism, wherein the controller maintains and makes adjustments to the speed of the first belt and/or the second belt so that the sensed gap distance is maintained at a predetermined gap distance.

2. The system of claim 1, wherein the first belt comprises a high friction belt.

3. The system of claim 1, wherein the second belt comprises a low friction belt.

4. The system of claim 1, wherein the sensing mechanism is selected from the group consisting of a photoelectric device, an ultrasonic device, a proximity device, a camera, a photoeye, an electronic switch, and a combination comprising at least one of the foregoing sensing mechanisms.

5. The system of claim 1, wherein the sensing mechanism senses a first time period which corresponds to the length of time for one article to pass by the sensing mechanism and the sensing mechanism farther senses a second time period which corresponds to the length of time between next adjacent articles.

6. The system of claim 1, wherein the controller determines an optimum line pressure value based on user inputted information and the controller will signal the first motor to adjust the speed of the first belt so as to cause the system to operate continuously at the optimum line pressure at any speed.

7. The system of claim 6, wherein the inputted information includes a length of the article, a processing speed which corresponds to a processing time for each article in a downstream location.

8. The system of claim 1, wherein the second belt is powered by a second motor or by power take-off from a subsequent machine.

9. A method for controlling line pressure in a conveyor system, comprising: moving a first article and a second article on a first belt assembly; passing the first article and the second article to a second belt; sensing a gap distance between the first article and the second article; and controlling the speed of the first belt and/or the second belt such that the sensed gap distance is substantially equivalent to a predetermined gap distance.
